(19) United States
(12) Patent Application Publication
(10) Pub. No.: US 2024/0182629 A1
(43) Pub. Date: Jun. 6, 2024

(54) POLYURETHANE FOAM EMISSIONS REDUCTION ADDITIVE

(71) Applicant: LEAR CORPORATION, Southfield, MI (US)

(72) Inventors: Matthew PHILLIPS, Farwell, MI (US); Chi-Fan HSU, Farwell, MI (US); Paul FIELDING, Farwell, MI (US); MiCHAEL WALKOWSKI, Lenox, MI (US); Gregory WETZEL, Farwell, MI (US); Jill GUNDERMAN, Clare, MI (US)

(21) Appl. No.: 18/059,536

(22) Filed: Nov. 29, 2022

(51) Int. Cl. C08G 18/76; C08G 18/42; C08G 18/48; C08J 9/14; C08K 5/521

(52) U.S. Cl. CPC C08G 18/7621; C08G 18/4238; C08G 18/48; C08J 9/142; C08K 5/521; C08G 2101/00

(57) ABSTRACT

A method for forming a polyurethane foam with reduced emissions is provided. The method includes a step of reacting a mixture comprising a polyol composition, an isocyanate composition, and a butylated triphenyl phosphate ester, The reaction forms a polyurethane foam. Characteristically, the butylated triphenyl phosphate ester is present in a sufficient amount to inhibit emission of propionaldehyde, formaldehyde, and acetaldehyde.

### TECHNICAL FIELD

In at least one aspect, the present invention methods for forming polyurethane foams with reduced emissions.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic flowchart illustrating a method for forming a polyurethane foam with reduced emissions.

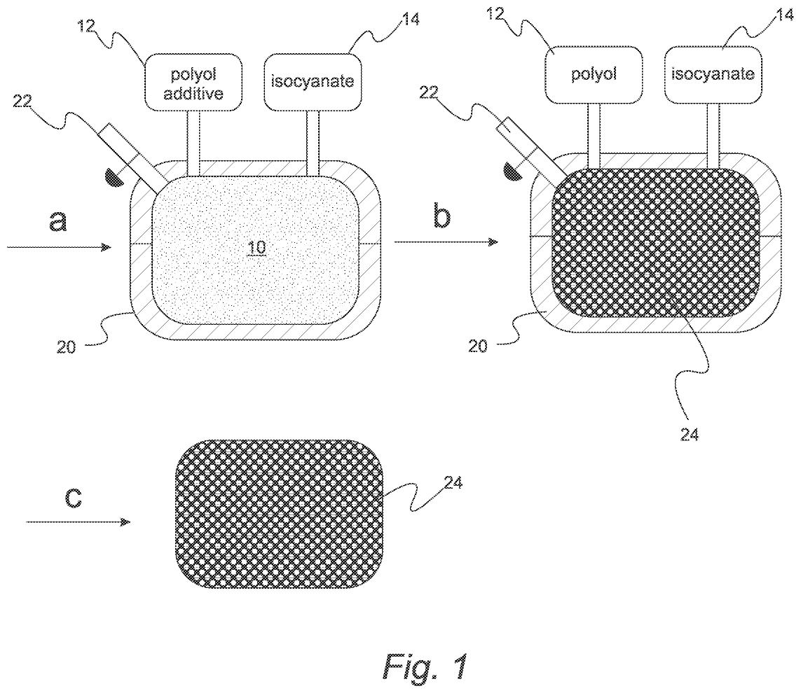

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R″′ are C₁₋₁₀ alkyl or C₆₋₁₈ aryl groups, M⁺ is a metal ion, and L⁻ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R″′)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃ M⁺, —PO₃⁻M⁺, —COOM⁺, —CF₂H, —CF₂R′, —CFH₂, and —CFR′R″ where R′, R″ and R″′ are C₁₋₁₀ alkyl or C₆₋₁₈ aryl groups, M⁻ is a metal ion, and L⁻ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present For example, “A and/or B” shall mean “only A, or only B, or both A and B”. In the case of “only A”. the term also covers the possibility that B is absent. i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4. . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The term “residue” means a portion, and typically a major portion, of a molecular entity, such as a molecule, or a part of a molecule such as a group, which has undergone a chemical reaction and is now covalently linked to another molecular entity. In a refinement, the term “residue” means an organic structure that is incorporated into the polymer by polycondensation or ring-opening polymerization reaction involving the corresponding monomer. In another refinement, the term “residue” when used in reference to a monomer or monomer unit means the remainder of the monomer unit after the monomer unit has been incorporated into the polymer chain. When a polymer component or a portion thereof does not react when included in a combination, the residue is the unreacted polymer component in reference to the combination.

The term “polyol” means an organic compound containing at least two hydroxyl groups. The term “polyol” includes compounds, monomers, oligomers and polymers containing at least two hydroxyl groups (such as diols) or at least three hydroxyl groups (such as triols), higher functional polyols and mixtures thereof. Suitable polyols are capable of forming a covalent bond with a reactive group, such as an isocyanate functional group.

The term “isocyanate” includes compounds, monomers, oligomers and polymers containing at least one or two —N═C═O functional groups and/or at least one or, at least two —N═C═S (isothiocyanate) groups. Monofunctional isocyanates can be used as chain-terminating agents or provide end groups during polymerization. As used herein, “polyisocyanate” means an isocyanate comprising at least two —N═C═O functional groups and/or at least two —N═C═S (isothiocyanate) groups, such as diisocyanates or triisocyanates, as well as isocyanate dimers and trimers or biurets discussed herein. Suitable isocyanates are capable of forming a covalent bond with a reaction group, such as a hydroxyl, thiol or amine functional group. The isocyanates used in the present invention may be branched or unbranched. As discussed above, the use of branched isocyanates may be desirable to increase the free volume inside the polymer matrix to provide space for the movement of molecules.

### Abbreviations

“ILD” means indentation load deflection.
“CFD” means compression force deflection.

In an embodiment, a method for forming a polyurethane foam with reduced emissions is provided. In step a), a polyurethane-forming mixture 10 is formed by mixing a polyol composition provided from polyol source 12, an isocyanate composition from isocyanate source 14, and a butylated triphenyl phosphate ester. In particular, the isocyanate composition includes a polyisocyanate. The butylated triphenyl phosphate ester can be premixed with either the isocyanate composition or the polyol composition. Typically, mixture 10 is formed in a mold 20 having vent 22 for venting reaction product gases. In step b), mixture 10 is reacted to form a polyurethane foam 24. Characteristically, the butylated triphenyl phosphate ester is present in a sufficient amount to inhibit the emission of propionaldehyde, formaldehyde, and acetaldehyde. The butylated triphenyl phosphate ester is present in an amount of at most 2 percent weight of the total weight of the mixture. In step c),

In a variation, the butylated triphenyl phosphate ester is present in an amount of at most, in increasing order of preference, 2 percent weight, 1.8 percent weight, 1.6 percent weight, 1.4 percent weight, 1.2 percent weight, 1.0 percent weight, 0.8 percent weight, or 0.6 percent weight of the total weight of the mixture. In a refinement, the butylated triphenyl phosphate ester is present in an amount of at least, in increasing order of preference, 0.05 percent weight, 0.1 percent weight, 0.15 percent weight, 0.2 percent weight, 0.25 percent weight, 0.3 percent weight, 0.35 percent weight, or 0.4 percent weight of the total weight of the mixture. In a further refinement, the butylated triphenyl phosphate ester is present in an amount from about 0.1 to 1 percent weight of the total weight of the mixture. In another refinement, the butylated triphenyl phosphate ester is present in an amount from about 0.1 to 0.8 percent weight of the total weight of the mixture.

In a variation, the butylated triphenyl phosphate ester is described by the following formula:

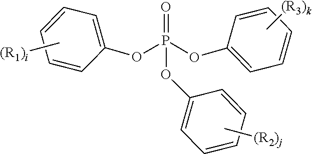

wherein:
R₁, R₂, R₃ are independently a butyl group (e.g., n-butyl, sec-butyl, t-butyl);
i is 1, 2, or 3; and
j, k are independently 0, 1, 2, or 3. In a refinement, the butylated triphenyl phosphate ester is a t-butyl triphenyl phosphate ester with at least one of R₁, R₂, R₃ being a t-butyl group. Examples of the t-butyl triphenyl phosphate ester are described by the following formulae:

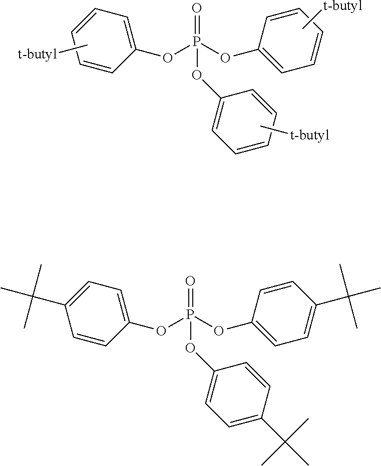

In another aspect, the polyol composition includes a liquid polyol. It should be appreciated that any suitable liquid polyol can be used. In a variation, the polyol composition includes a component from the group consisting of polyether polyols, polyester polyols, and combinations thereof. In one variation, the polyol is a polyol polymer, and in particular a polyoxyalkylene polyol In a refinement, the polyol employed is a polyether polyol. In another refinement, the polyol composition includes a polymer-modified polyol (“polymer polyols”).

In another aspect, each isocyanate in the isocyanate composition includes at least two isocyanate functional groups (i.e., a polyisocyanate). Examples of isocyanate are selected from the group consisting of: aliphatic isocyanates, cycloaliphatic isocyanates and/or aromatic isocyanates. Typically, the isocyanate is a triisocyanate and/or a diisocyanate. In a refinement, the isocyanate is a triisocyanate. Examples of suitable triisocyanates include, but are not limited to, 1,3,5-triisocyanate, toluene 2,4,6-triisocyanate, triphenylmethane 4,4′,4 ″-triisocyanate, or the like, and/or combinations thereof. In a refinement, the isocyanate is a diisocyanate. Examples of suitable diisocyanates include, but are not limited to, trimethylene diisocyanate, tetramethylene diisocyanate, pentamethylene diisocyanate, hexamethylene diisocyanate, heptamethylene diisocyanate and/or octamethylene diisocyanate, 2-methylpentamethylene-1,5-diisocyanate, 2-ethylbutylene-1,4-diisocyanate, pentamethylene-1,5-diisocyanate, butylene-1, 4-diisocyanate, 1-isocyanato-3,3,5-trimethyl-S-isocyanatomethylcyclohexane (1-isocyanato-3,3,5-trimethy-5-isocyanatomethyl cyclohexane) (isophorone diisocyanate, IPDI), 1,4-bis (isocyanatomethyl) cyclohexane and/or 1,3-bis (isocyanatomethyl) cyclohexane (HXDI), cyclohexane-1,4-diisocyanate, 1-methylcyclohexane 2,4-diisocyanate and/or 1-methylcyclohexane 2,6-diisocyanate and/or dicyclohexylmethane 4,4′-diisocyanate, dicyclobexylmethane 2,4′-diisocyanate and dicyclohexylmethane 2,2″-diisocyanate, diphenylmethane 2,4′-diisocyanate and/or diphenylmethane 4,4″-diisocyanate (MDI), naphthylene 1,5-diisocyanate (NDI), Tolylene 2,4-diisocyanate and/or tolylene 2,6-diisocyanate (TDI). diphenylmethane diisocyanate, 3′-dimethylbiphenyl diisocyanate, 1,2-diphenylethane diisocyanate and/or phenylene diisocyanate and/or combinations thereof. Particualry, useful isocyanates are multifunctional organic isocyanates selected from the group consisting of 4,4′-diphenylmethane diisocyanate (MDI), toluene diisocyanate (TDI), hexamethylene diisocyanate (HMDI), isophorone diisocyanate isocyanate (IPDI), and combinations thereof.

In another aspect, the mixture includes a blowing agent. Blowing agents are volatile compounds that react with isocyanates to produce a gas. These gases reduce the density and promote the formation of rigid foam. In one refinement, the blowing agent is selected from the group consisting of water, acetone, methanol, halogenated olefins, ethyl acetate, and/or combinations thereof. In a refinement, the blowing agent used is water, which is present in an amount from about 0.5 to 5 weight percent of the total weight of the composition used to form the polyurethane foam. In a refinement, the blowing agent is present in an amount from about 0.8 weight percent to 4 weight percent of the total weight of the composition used to form the polyurethane foam. In yet another refinement, the blowing agent is present in an amount from about 1.2 weight percent to 3 weight percent of the total weight of the composition used to form the polyurethane foam.

In a refinement, the balance of the composition is water. In another aspect, a stoichiometric ratio of isocyanates to polyols is from 0.10 to 10. In some refinements, the stoichiometric ratio of isocyanates to polyols is at least 0.05, 0.10, 0.20, 0.30, 0.40, or 0.50. In some refinements, the stoichiometric ratio of isocyanates to polyols is at most 10, 9, 8, 7, 6, or 0.55.

In another embodiment, a foamed article formed by the methods described herein is provided. The foamed article includes a polyurethane foam that includes isocyanate residues, polyol residues, and butylated triphenyl phosphate ester residues. As set forth above, the butylated triphenyl phosphate ester residues present in an amount less than about 2.0 percent weight of the total weight of the polyurethane foam, butylated triphenyl phosphate or residues thereof are present in an amount from about 0.1 to 2 weight percent of the total weight of the polyurethane foam, wherein the polyurethane foam includes open cells or closed cells dispersed therein.

In a variation, the butylated triphenyl phosphate ester residues are present in an amount of at most, in increasing order of preference, 2 percent weight, 1.8 percent weight, 1.6 percent weight, 1.4 percent weight, 1.2 percent weight, 1.0 percent weight, 0.8 percent weight, or 0.6 percent weight of the total weight of the polyurethane foam. In a refinement, the butylated triphenyl phosphate ester residues are present in an amount of at least, in increasing order of preference, 0.05 percent weight, 0.1 percent weight, 0.15 percent weight, 0.2 percent weight, 0.25 percent weight, 0.3 percent weight, 0.35 percent weight, or 0.4 percent weight of the total weight of the polyurethane foam. In a further refinement, the butylated triphenyl phosphate ester is present in an amount from about 0.1 to 1 percent weight of the total weight of the polyurethane foam. In another refinement, the butylated triphenyl phosphate ester is present in an amount from about 0.1 to 0.8 percent weight of the total weight of the polyurethane foam.

In a variation, the butylated triphenyl phosphate ester residues are present in an amount from about 0.1 to 1 weight percent of the total weight of the polyurethane foam. In a refinement, the butylated triphenyl phosphate ester residues are present in an amount from about 0.1 to 0.8 weight percent of the total weight of the polyurethane foam.

In another aspect, the butylated triphenyl phosphate ester residues are t-butyl triphenyl phosphate ester residues. Details for t-butyl triphenyl phosphate ester are set forth above.

In another aspect, the polyol residues include a component from the group consisting of polyether polyol residues, polyester polyols residues, and combinations thereof. Details for the polyol are set forth above.

In a refinement, the isocyanate residue includes carbamate links formed from the at least two isocyanate functional groups. In a refinement, the isocyanate residues include multifunctional organic isocyanate residues selected from the group consisting of 4,4′-diphenylmethane diisocyanate residues, toluene diisocyanate residues, hexamethylene diisocyanate residues, isophorone diisocyanate isocyanate residues, and combinations thereof.

In a variation, the open cells or closed cells are formed from a blowing agent as set forth above.

In another aspect, the stoichiometric ratio of the isocyanate residues to the polyol residues is from 0.10 to 10. In a refinement, the stoichiometric ratio of the isocyanate residues to the polyol residues is at least 0.10, 0.05, 1, 2, 3, or 5. In a further refinement, a stoichiometric ratio of the isocyanate residues to the polyol residues is at most 12, 10, 9, 8, 7 or 6.

The following examples illustrate the various embodiments of the present invention. Those skilled in the art will recognize many variations that are within the spirit of the present invention and scope of the claims.

Table 1 provides emissions results for a foam formed with butylated triphenyl phosphate as compared to a control foam and a foam formed with a commercial aldehyde scavenger. The foams formed with butylated triphenyl phosphate show significant reduction in propionaldehyde, formaldehyde, and acetaldehyde as compared to a control and a foam formed with a commercial aldehyde scavenger. Table 2 provides physical property results and Table 3 provide reactivity profile results for the foams.

TABLE 1
Emissions Results

| | | | | Commercial | Butylated |
|---|---|---|---|---|---|
| | Proposed | | | Aldehyde | Triphenyl |
| Component | Requirement | | Control | Scavenger | Phosphate |
| | | | | 0.75% | 0.25% |
| Acrolein | <50 | μ/m³ | ND | ND | ND |
| Propionaldehyde | | | 316 | 496 | 124 |
| Change - | | | | ↑ 57% | ↓ 61% |
| Propionaldehyde | | | | | |
| Acetone | | | 0 | 0 | 0 |
| Formaldehyde | <100 | μ/m³kg | 861 | 157 | 341 |
| Change - | | | | ↓ 81% | ↓ 60% |
| Formaldehyde | | | | | |
| Acetaldehyde | <100 | μ/m³kg | 90 | 563 | 23 |
| Change - | | | | ↑ 525% | ↓ 74% |
| Acetaldehyde | | | | | |

TABLE 2
Physical Property Results

| | | | Commercial | | Commercial | | Butylated | |
|---|---|---|---|---|---|---|---|---|
| | | | Aldehyde | | Aldehyde | | Triphenyl | |
| Specification | Control | | Scavenger | | Scavenger | | Phosphate | |
| Percent Additive | 0.00% | | 0.75% | | 1.30% | | 0.25% | |
| Density | 64.1 | kg/m³ | 64.3 | kg/m³ | 64.7 | kg/m³ | 64.4 | kg/m³ |
| Core Density | 55.1 | kg/m³ | 55.1 | kg/m³ | 55.3 | kg/m³ | 56.6 | kg/m³ |
| ILD - (25/50/65) | 209/349/521 | | 181/309/461 | | 152/262/392 | | 219/372/554 | |
| Comfort Factor | 2.5 | | 2.5 | | 2.6 | | 2.5 | |
| Ball Rebound | 55.8% | | 52.0% | | 47.5% | | 56.2% | |
| CFD | 14.8N | | 13.3N | | 11.0N | | 15.0N | |
| CFD | 6.1 | kPa | 5.4 | kPa | 4.5 | kPa | 6.2 | kPa |
| Hysteresis Loss | 22.9% | | 26.0% | | 29.2% | | 23.1% | |
| Dry Compression Set | 6.3% | | 8.4% | | 12.9% | | 6.0% | |
| Wet Compression Set | 8.9% | | 11.0% | | 18.4% | | 8.5% | |
| Tensile | 120 | N/m | 108 | N/m | 89 | N/m | 114 | N/m |
| Tear | 621 | kPa | 578 | kPa | 470 | kPa | 623 | kPa |

| | | | | |
|---|---|---|---|---|
| Elongation | 117% | 113% | 107% | 114% |
| Burn Rate | None | None | None | None |
| Rating | SE/NBR | SE/NBR | SE/NBR | SE/NBR |

TABLE 3
Reactivity Profile Results.

| | | | Commercial | | Commercial | | Butylated | |
|---|---|---|---|---|---|---|---|---|
| | | | Aldehyde | | Aldehyde | | Triphenyl | |
| Specification | Control | | Scavenger | | Scavenger | | Phosphate | |
| Percent Additive | 0.00% | | 0.75% | | 1.30% | | 0.25% | |
| Top of Cup | 31.9 | sec | 33.5 | sec | 31.7 | sec | 33.2 | sec |
| Rise Time | 67.5 | sec | 65.4 | sec | 56.2 | sec | 73.0 | sec |
| Max Viscosity | 20.9 | sec | 22.3 | sec | 24.1 | sec | 25.0 | sec |
| Min Viscosity | 84.0 | sec | 80.4 | sec | 67.8 | sec | 90.9 | sec |
| Time to Max Temp | 271.2 | sec | 240.1 | sec | 238.2 | sec | 302.3 | sec |
| Max Temp | 101.8° | C. | 99.6° | C. | 101.2° | C. | 101.7° | C. |
| Final Height | 180.3 | mm | 184.3 | mm | 183.9 | mm | 183.9 | mm |
| % Shrinkage | 10.1% | | 7.9% | | 8.1% | | 6.8% | |
| Top of Vent - Mold | 30 | sec | 28 | sec | 26 | sec | 30 | sec |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
reacting a mixture comprising:
a polyol composition,
an isocyanate composition, and
a butylated triphenyl phosphate ester,
the reaction forming a polyurethane foam,
the butylated triphenyl phosphate ester present in a sufficient amount to inhibit emission of propionaldehyde, formaldehyde, and acetaldehyde.

2. The method of claim 1, wherein the butylated triphenyl phosphate ester is present in an amount of at most 2 percent weight of the total weight of the mixture.

3. The method of claim 1, wherein the butylated triphenyl phosphate ester is present in an amount from about 0.1 to 1 percent weight of the total weight of the mixture.

4. The method of claim 1, wherein the butylated triphenyl phosphate ester is present in an amount from about 0.1 to 0.8 percent weight of the total weight of the mixture.

5. The method of claim 1, wherein the butylated triphenyl phosphate ester is t-butyl triphenyl phosphate ester.

6. The method of claim 1, wherein the polyol composition includes a component from the group consisting of polyether polyols, polyester polyols, and combinations thereof.

7. The method of claim 1, wherein each isocyanate in the isocyanate composition includes an isocyanate having at least two isocyanate functional groups.

8. The method of claim 1, wherein the isocyanate composition includes multifunctional organic isocyanates selected from the group consisting of 4,4′-diphenylmethane diisocyanate (MDI), toluene diisocyanate (TDI), hexamethylene diisocyanate (HMDI), isophorone diisocyanate isocyanate (IPDI), and combinations thereof.

9. The method of claim 1, wherein the mixture includes a blowing agent.

10. The method of claim 1, wherein a stoichiometric ratio of isocyanates to polyols is from 0.10 to 10

11. A foamed article comprising:
a polyurethane foam, the polyurethane foam comprising:
isocyanate residues,
polyol residues, and
butylated triphenyl phosphate ester residues, the butylated triphenyl phosphate ester residues present in an amount less than about 2.0 percent weight of the total weight of the polyurethane foam, butylated triphenyl phosphate or residues thereof are present in an amount from about 0.1 to 2 weight percent of the total weight of the polyurethane foam, wherein the polyurethane foam includes open cells or closed cells dispersed therein.

12. The foamed article of claim 11, wherein the butylated triphenyl phosphate ester residues are present in an amount from about 0.1 to 1 weight percent of the total weight of the polyurethane foam.

13. The foamed article of claim 11, wherein the butylated triphenyl phosphate ester residues are present in an amount from about 0.1 to 0.8 weight percent of the total weight of the polyurethane foam.

14. The foamed article of claim 11, wherein the butylated triphenyl phosphate ester residues are t-butyl triphenyl phosphate ester residues.

15. The foamed article of claim 11, wherein the polyol residues includes a component from the group consisting of polyether polyol residues, polyester polyols residues, and combinations thereof.

16. The foamed article of claim 11, wherein each isocyanate residue includes carbamide links from at least two isocyanate functional groups.

17. The foamed article of claim 11, wherein the isocyanate residues include multifunctional organic isocyanate residues selected from the group consisting of 4,4′-diphenylmethane diisocyanate residues, toluene diisocyanate residues, hexamethylene diisocyanate residues, isophorone diisocyanate isocyanate residues, and combinations thereof.

18. The foamed article of claim 11, wherein the open cells or closed cells are formed from a blowing agent.

19. The foamed article of claim 11, wherein a stoichiometric ratio of the isocyanate residues to the polyol residues is from 0.10 to 10.
